(19) United States
(12) Patent Application Publication
(10) Pub. No.: US 2013/0242116 A1
(43) Pub. Date: Sep. 19, 2013

(54) IMAGE PROCESSING APPARATUS, ELECTRONIC DEVICE, IMAGE PROCESSING METHOD, AND PROGRAM

(71) Applicant: SONY CORPORATION, Tokyo (JP)

(72) Inventors: Takeyuki Fujii, Tokyo (JP); Shoichi Suzuki, Kanagawa (JP)

(73) Assignee: SONY CORPORATION, Tokyo (JP)

(21) Appl. No.: 13/772,448

(22) Filed: Feb. 21, 2013

(30) Foreign Application Priority Data
Mar. 13, 2012 (JP) 2012-055223

(51) Int. Cl. H04N 17/00

(52) U.S. Cl. CPC H04N 17/00
USPC 348/180

(57) ABSTRACT

There is provided an image processing apparatus including an evaluation information generation section which generates, based on a moving image and a frame rate of the moving image, evaluation information for specifying an image quality of the moving image in displaying the moving image at the frame rate, and a determination section which determines a parameter for adjusting the image quality of the moving image based on the generated evaluation information.

### BACKGROUND

The present technology relates to an image processing apparatus. The present technology particularly relates to an image processing apparatus handling a moving image, an electronic device, an image processing method therefor, and a program causing a computer to execute the image processing method.

In recent years, there have been realized an apparatus which generates a moving image by capturing an image of a subject and an apparatus which reproduces the generated moving image. In such apparatuses, predetermined image processing is performed on images forming a moving image to display a moving image easy to view for a user, and then the moving image subjected to such image processing is recorded and reproduced.

There is proposed as an apparatus performing such image processing a video reproducing device which sets the strength of the image processing in accordance with the bit rate of a moving image, for example (see JP 2000-350144A, for example).

### SUMMARY

In the related art, the moving image can be viewed in an optimum state in accordance with the bit rate of the moving image.

However, there are also assumed cases in which the image quality is different but the bit rate is the same. In even such cases, it is important to set an appropriate image processing strength in accordance with the image quality.

The present technology has been produced in view of such circumstances. It is desirable to appropriately determine a parameter for adjusting an image quality of a moving image.

The present technology is provided to solve the above-mentioned issues. According to a first embodiment of the present disclosure, there is provided an image processing apparatus, an image processing method and a program including an evaluation information generation section which generates, based on a moving image and a frame rate of the moving image, evaluation information for specifying an image quality of the moving image in displaying the moving image at the frame rate, and a determination section which determines a parameter for adjusting the image quality of the moving image based on the generated evaluation information. In this way, there is provided an effect in which the evaluation information for specifying the image quality of the moving image in displaying the moving image at the frame rate of the moving image is generated based on the moving image and the frame rate, and in which the parameter for adjusting the image quality of the moving image is determined based on the generated evaluation information.

Further, according to the first embodiment of the present disclosure, the evaluation information may be information for specifying an image quality of one of images forming the moving image displayed at the frame rate, the image being perceived by a user at a time of viewing. The evaluation information generation section may generate the evaluation information based on the image, the frame rate, and visual information on a vision of the user. In this way, there is provided an effect in which the evaluation information indicating the image quality of the image perceived by the user at the time of viewing is generated based on the image, the frame rate, and the visual information on the vision of the user.

Further, according to the first embodiment of the present disclosure, the visual information may be information indicating a predetermined time period related to an after-image perceived by the user. The evaluation information generation section may calculate a number of images displayed in the predetermined time period based on the frame rate, and generates as the evaluation information an amount of noise specified based on the calculated number of images. In this way, there is provided an effect in which the evaluation information is generated by using the predetermined time period related to the after-image perceived by the user.

Further, according to the first embodiment of the present disclosure, the predetermined time period may be a time period approximate to a time period of a time resolution of the vision. In this way, there is provided an effect in which the evaluation information is generated by using the time period of the time resolution of the vision.

Further, according to the first embodiment of the present disclosure, the amount of noise may include a random noise amount which is an amount of random noise and a fixed-pattern noise amount which is an amount of fixed-pattern noise. And the evaluation information generation section may calculate the random noise amount based on the amount of noise of the image, the number of images displayed in the predetermined time period, and the fixed-pattern noise amount, and generate as the evaluation information the specified amount of noise based on a sum of the calculated random noise amount and the fixed-pattern noise amount. In this way, there is provided an effect in which the amount of noise is calculated based on the amount of noise of the one image, the number of images, and the fixed-pattern noise amount.

Further, according to the first embodiment of the present disclosure, among the images forming the moving image, the evaluation information generation section may combine images a number of which is equal to the number of images into a combined image, and generate the evaluation information which is an amount of noise in the combined image. In this way, there is provided an effect in which the amount of noise is calculated by using the combined image generated by combining as many images as the number of images displayed in the predetermined time period.

Further, according to the first embodiment of the present disclosure, the determination section may determine as the parameter at least one of a parameter for adjusting a degree of noise reduction, a parameter for adjusting a degree of color reproducibility of a color matrix, or a parameter for adjusting a setting for image capturing. In this way, there is provided an effect in which at least one of the parameter for adjusting the degree of noise reduction, the parameter for adjusting the degree of color reproducibility of the color matrix, and the parameter for adjusting the setting for image capturing is determined.

According to a second embodiment of the present disclosure, there is provided an electronic device including an evaluation information generation section which generates, based on a moving image and a frame rate of the moving image, evaluation information for specifying an image quality of the moving image in displaying the moving image at the frame rate, a determination section which determines a parameter for adjusting the image quality of the moving image based on the generated evaluation information, and an output section which outputs the moving image adjusted by using the determined parameter. In this way, there is provided an effect in which the evaluation information for specifying the image quality of the moving image in displaying the moving image at the frame rate of the moving image is generated based on the moving image and the frame rate, and in which the parameter for adjusting the image quality of the moving image is determined based on the generated evaluation information.

The present technology can exert an excellent effect in which a parameter for adjusting an image quality of a moving image can be appropriately determined.

### BRIEF DESCRIPTION OF THE DRAWINGS

FIG. 1 is a block diagram showing a functional configuration example of an image processing apparatus 10 in a first embodiment of the present technology;

FIG. 2 is a diagram schematically showing an amount of noise taken into consideration when a parameter determination section 170 determines a parameter;

FIG. 3 illustrates: a table showing variation in perceived noise amount depending on the frame rate of a moving image to be subjected to image processing by a moving-image processing section 100 in the first embodiment of the present technology; and a table showing variation in the degree of blur, of an image, caused by a noise reduction effect;

FIG. 4 is a diagram schematically showing how the moving-image processing section 100 in the first embodiment of the present technology determines a parameter;

FIG. 5 is a flowchart showing an example of a procedure in image processing performed by the image processing apparatus 10 in the first embodiment of the present technology;

FIG. 6 is a flowchart showing an example of a procedure of fixed-pattern-noise-amount calculation processing (Step S920) in the image processing procedure in the first embodiment of the present technology;

FIG. 7 is a flowchart showing an example of a procedure of reference-noise-amount calculation processing (Step S930) in the image processing procedure in the first embodiment of the present technology;

FIG. 8 is a flowchart showing an example of a procedure of parameter determination processing (Step S940) in the image processing procedure in the first embodiment of the present technology;

FIG. 9 is a flowchart showing an example of a procedure in determining a parameter for each image forming a moving image in the first embodiment of the present technology;

FIG. 10 is a block diagram showing a functional configuration example of an image processing apparatus (an image processing apparatus 30) in a second embodiment of the present technology;

FIG. 11 is a diagram schematically showing how a moving-image processing section 300 in the second embodiment of the present technology determines a parameter;

FIG. 12 is a flowchart showing an example of a procedure used in image processing performed by the image processing apparatus 30 in the second embodiment of the present technology;

FIG. 13 is a flowchart showing an example of a procedure of parameter determination processing (Step S960) in the image processing procedure in the second embodiment of the present technology;

FIG. 14 is a block diagram showing a functional configuration example of an image processing apparatus (an image processing apparatus 50) in a third embodiment of the present technology;

FIG. 15 is a table showing an example of a parameter list used when a moving-image processing section 500 in the third embodiment of the present technology determines a parameter; and

FIG. 16 is a flowchart showing an example of a procedure used in image processing performed by the image processing apparatus 50 in the third embodiment of the present technology.

### DETAILED DESCRIPTION OF THE EMBODIMENTS

Hereinafter, descriptions will be given of modes for carrying out the present technology (hereinafter, referred to as embodiments). The descriptions will be given in the following order.

1. First embodiment (image processing control: an example of estimating an amount of noise perceived by a user based on one image)

2. Second embodiment (image processing control: an example of estimating an amount of noise perceived by the user based on an image combined from a plurality of images)

3. Third embodiment (image processing control: an example of determining a parameter for image processing based on an amount of perceived noise and a list of parameters)

### 1. First Embodiment

[Functional Configuration Example of Image Processing Apparatus]

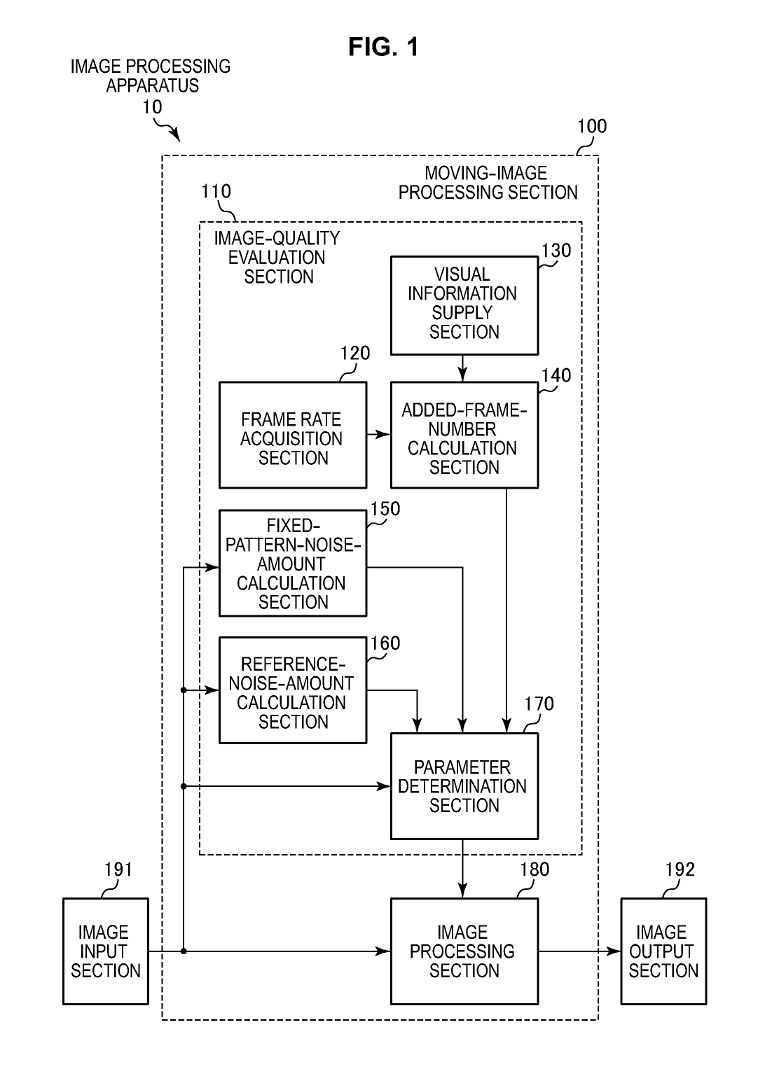

FIG. 1 is a block diagram showing a functional configuration example of an image processing apparatus 10 in a first embodiment of the present technology.

Note that the descriptions will be given in the embodiments of the present technology on the assumption that the image processing apparatus 10 is an image-capturing apparatus such as a digital still camera. Further, the image processing apparatus 10 is applicable to a video viewing apparatus (for example, a recorder with a built-in hard disk) which records or displays moving image content externally input.

The image processing apparatus 10 includes an image input section 191, a moving-image processing section 100, and an image output section 192.

The image input section 191 inputs a moving image (an image sequence) and supplies the moving-image processing section 100 with the input image sequence. For example, when the image-capturing apparatus such as the digital still camera is the image processing apparatus 10, the moving-image processing section 100 is supplied with data (an image sequence) of temporally continuous images obtained by performing predetermined signal processing on images acquired by an image sensor. Note that the predetermined signal processing performed on the acquired images corresponds to, for example, AD conversion, black level correction, defect correction, shading correction, mixed color correction, white balance correction, γ correction, demosaic processing, or the like.

Note that when the image processing apparatus 10 is a video viewing apparatus, the image input section 191 supplies the moving-image processing section 100 with the image sequence read from a recording medium.

The moving-image processing section 100 determines a parameter in performing image processing on the images forming the image sequence based on a frame rate and the image quality of the images (frames) and performs the image processing by using the determined parameter. The moving-image processing section 100 includes an image-quality evaluation section 110 and an image processing section 180.

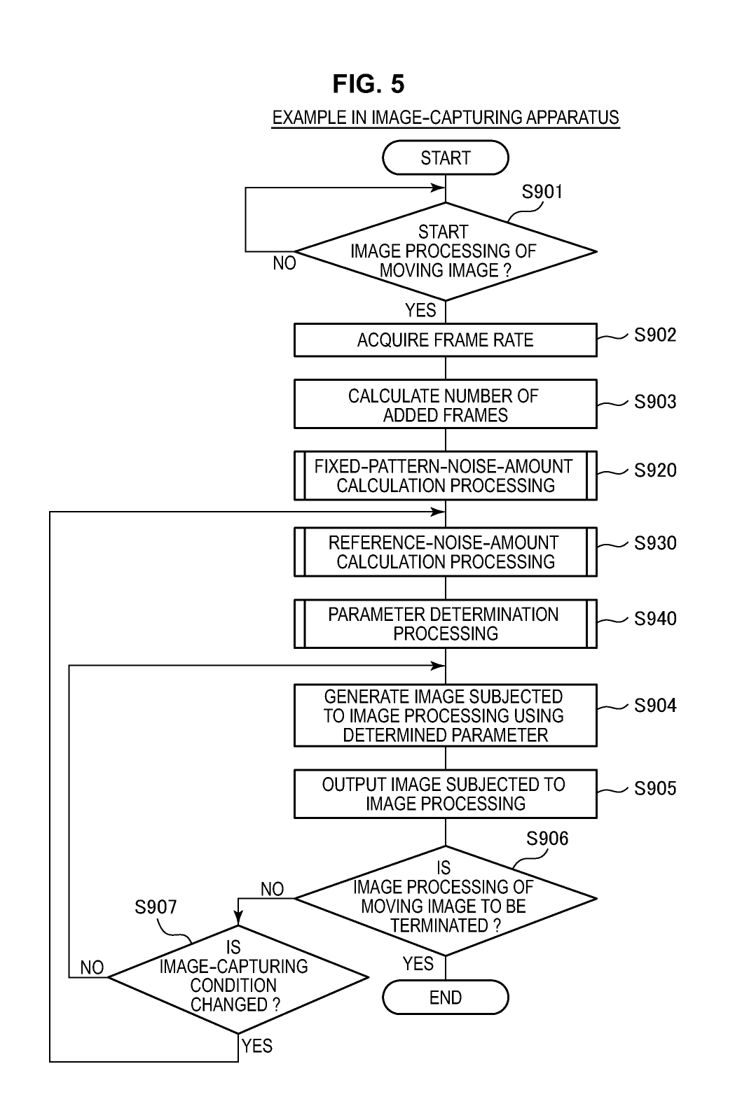

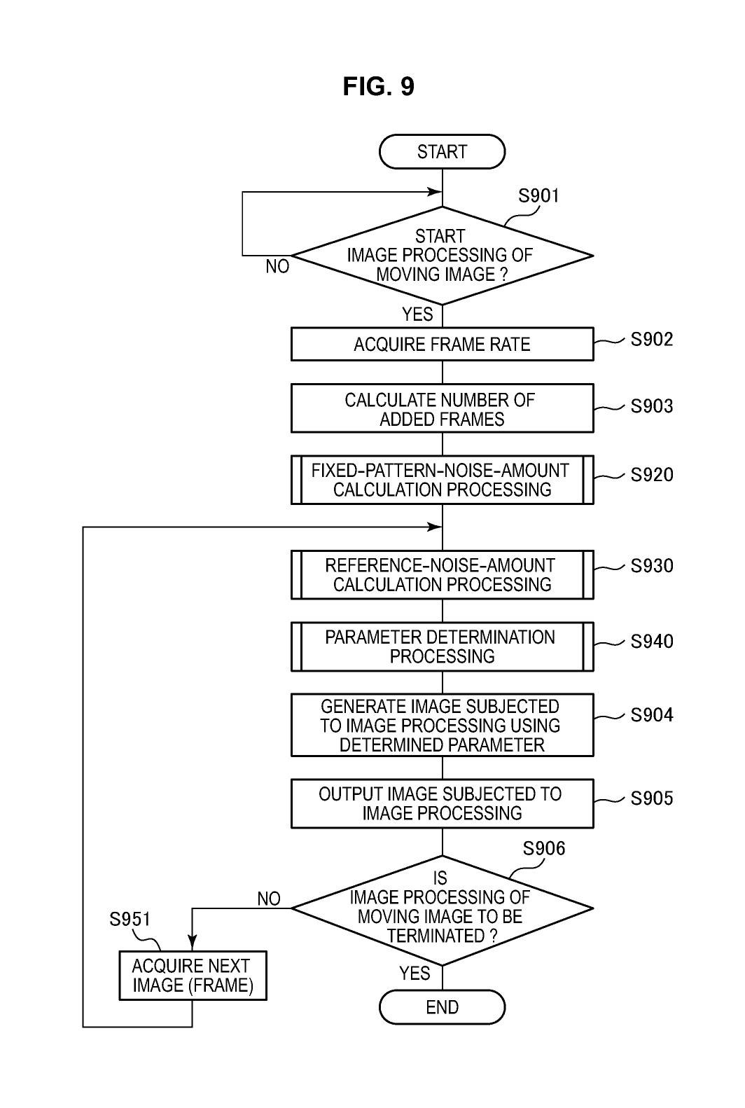

The image-quality evaluation section 110 evaluates the quality of the images forming the image sequence based on the frame rate and the image quality of the images, and determines the parameter for the image processing based on the evaluation. The image-quality evaluation section 110 supplies the image processing section 180 with the determined parameter. Note that various examples are conceivable as parameter determination timing An example of generating a new parameter at timing when the image quality changes largely will be described with reference to a flowchart in FIG. 5. Further, an example of generating a parameter for each image forming the image sequence will be described with reference to a flowchart in FIG. 9.

Note that the image-quality evaluation section 110 includes a frame rate acquisition section 120, a visual information supply section 130, an added-frame-number calculation section 140, a fixed-pattern-noise-amount calculation section 150, a reference-noise-amount calculation section 160, and a parameter determination section 170.

The frame rate acquisition section 120 acquires speed (a frame rate) at which the image sequence (the moving image) supplied from the image input section 191 is reproduced. When the image processing apparatus 10 is, for example, the image-capturing apparatus, the frame rate acquisition section 120 acquires the image-capturing speed (the frame rate) of the image sensor from a control section (not shown). Note that in the case where the image processing apparatus 10 is the video viewing apparatus, the frame rate acquisition section 120 acquires information on the frame rate among file information embedded in a moving image file. Also in this case where the image processing apparatus 10 is the video viewing apparatus, when the information on the frame rate is not embedded in the moving image file or when reproduction is performed at any changed reproduction speed, a user may input the frame rate.

The frame rate acquisition section 120 supplies the added-frame-number calculation section 140 with the acquired frame rate.

The visual information supply section 130 supplies information on an after-image perceived by the user (a human) viewing the image sequence. A human vision has a time resolution, and thus light blinking in a shorter time period than a time period of the time resolution is perceived (recognized) as continuous lighting. This impact is called an after-image effect. Also in the case of displaying a moving image, the user is influenced by the after-image effect to perceive images in such a way that several frames displayed within the time resolution of the human vision are added up. Hence, the visual information supply section 130 holds, as visual information, a time period during which the after-image effect occurs. For example, the visual information supply section 130 holds a time period (about 80 msec to 120 msec) of the time resolution as the visual information. The visual information supply section 130 supplies the added-frame-number calculation section 140 with the visual information.

Based on the frame rate supplied from the frame rate acquisition section 120 and the visual information supplied from the visual information supply section 130, the added-frame-number calculation section 140 calculates the number of added frames. Here, the number of added frames is the number of frames used when images perceived in the human vision are assumed. In other words, the number of added frames is the number of images displayed by a display section (not shown) in a predetermined time period which is the time resolution of the human vision when the image sequence supplied by the image input section 191 is viewed (observed) by the user.

The number of added frames (n) is calculated in accordance with the following Formula 1, for example:

n=ατ Formula 1

where α denotes the frame rate (unit: fps). Further, τ denotes a time period (sec) indicated by the visual information.

The added-frame-number calculation section 140 supplies the parameter determination section 170 with the calculated number of added frames.

The fixed-pattern-noise-amount calculation section 150 calculates an amount of fixed-pattern noise (a fixed-pattern noise amount) among noise included in the images forming the image sequence and supplies the parameter determination section 170 with the calculated fixed-pattern noise amount.

The fixed-pattern-noise-amount calculation section 150 performs averaging on a plurality of images, for example, in the image sequence supplied from the image input section 191 (for example, several tens of images from the start image (frame) in a file to be subjected to the moving image processing, and generates an image from which random noise is eliminated and which includes only the fixed-pattern noise. Note that the larger the number of images to be added up in this case is, the more accurately the fixed-pattern noise can be calculated.

Then, the fixed-pattern-noise-amount calculation section 150 calculates the fixed-pattern noise amount by calculating a noise amount in the image including only the fixed-pattern noise. Note that a known method such as a method using a standard deviation, a visual noise calculation method standardized in ISO 15739, or the like can be used as a method of calculating the amount of noise. Note that the reference-noise-amount calculation section 160 and the parameter determination section 170 also calculate the amount of noise by using the same method.

Note that the method of calculating the fixed-pattern noise amount using the averaging of the plurality of images can calculate the fixed-pattern noise amount even if the image processing apparatus 10 is the image-capturing apparatus or even if the image processing apparatus 10 is the video viewing apparatus. Further, when the image processing apparatus 10 is the image-capturing apparatus, it is possible to calculate the fixed-pattern noise amount in advance by measuring the fixed-pattern noise at the time of manufacturing the image-capturing apparatus and to hold the calculated fixed-pattern noise amount in a memory. In this case, image capturing is performed with long-time exposure to generate an image including only the fixed-pattern noise, and then the fixed-pattern noise amount is calculated by using the generated image. The fixed-pattern-noise-amount calculation section 150 supplies the parameter determination section 170 with the calculated fixed-pattern noise amount.

The reference-noise-amount calculation section 160 calculates an amount of noise (a reference noise amount) at the time when a parameter for a still image is applied to one of the images forming the image sequence. Here, the parameter for a still image is a parameter leading to an appropriate image to be viewed by the user, the image being displayed as a still image. The reference-noise-amount calculation section 160 applies the parameter for a still image to the one image in the image sequence supplied from the image input section 191 and generates an image (a still-image-parameter-applied image) to which the parameter for a still image is applied.

Then, the reference-noise-amount calculation section 160 calculates a noise amount (the reference noise amount) in the still-image-parameter-applied image. The reference-noise-amount calculation section 160 supplies the parameter determination section 170 with the calculated reference noise amount.

The parameter determination section 170 determines a parameter in performing image processing on each image forming the image sequence. The parameter determination section 170 determines the parameter, based on the number of added frames supplied from the added-frame-number calculation section 140, the fixed-pattern noise amount supplied from the fixed-pattern-noise-amount calculation section 150, and the reference noise amount supplied from the reference-noise-amount calculation section 160.

Here, a description is given of the parameter determination by the parameter determination section 170. As in the description of the visual information, the user perceives an image formed by adding up the plurality of frames displayed in the time resolution of the human vision. Since random noise included in images appears at random positions in the images, adding up more images leads to less random noise. In other words, when a still image and a moving image have the same noise amount, a less noise amount is perceived in the case of viewing the moving image than in the case of viewing the still image. For this reason, applying the parameter for a still image to an image to be displayed as a moving image leads to a too high noise reduction effect.

Note that when the noise reduction effect in the image processing is made higher, resolutions are lowered (an image is more blurred), or color reproducibility is deteriorated. In sum, in displaying an image as a moving image, determining the image processing parameter based on a noise amount of an image to be perceived makes it possible to perform the image processing at noise reduction strength appropriate for displaying an image as a moving image.

Hence, the parameter determination section 170 calculates a noise amount in an image resulting from the addition (combining) based on the number of added frames, and determines the image processing parameter based on the calculated noise amount (hereinafter, referred to as an added-image noise amount).

Here, a description is given of calculation of the added-image noise amount by the parameter determination section 170. Firstly, the parameter determination section 170 calculates a noise amount (A) in a parameter determination target image. Then, based on the number of added frames (n), the noise amount (A) of the parameter determination target image, and a fixed-pattern noise amount (B), the parameter determination section 170 calculates a noise amount (A′) resulting from the frame addition. Note that the noise amount (A′) is calculated, for example, in accordance with the following Formula 2:

$${A}^{′} = \frac{A - B}{\sqrt{n}} + B . \qquad Formula 2$$

Here, a description is given of Formula 2 mentioned above. Firstly, a description is given of a relation among a random noise amount, the fixed-pattern noise amount, and an overall noise amount of an image. The overall noise amount of an image is noise including random noise and fixed-pattern noise. In other words, a relation shown by the following Formula 3 holds true for the noise amount (A) in the parameter determination target image, the fixed-pattern noise amount (B), and a random noise amount (C) in the parameter determination target image.

C=A−B Formula 3

Next, a description will be given of the random noise amount in an image resulting from the frame addition. The random noise is reduced in accordance with the number of added frames. Note that when N images are added up, the random noise is generally reduced to 1/√N. In other words, the random noise amount (C′) reduced after adding up the frames can be calculated as in the following Formula 4 by using the number of added frames (N), the noise amount (A) in the parameter determination target image, and the fixed-pattern noise amount (B).

$${C}^{′} = \frac{A - B}{\sqrt{n}} \qquad Formula 4$$

Note that the noise amount (A′) after adding up N frames is obtained in accordance with the following Formula 5:

A′=C′+B Formula 5.

Then, substituting Formula 4 for Formula 5 results in Formula 2. In other words, by utilizing the reduction of the random noise to 1/√N after adding up the N images, the noise amount (A′) resulting from the frame addition can be calculated by using Formula 2 mentioned above without generating an image after the addition.

Next, a description will be given of the parameter determination based on the calculated noise amount (A′). The parameter determination section 170 determines a parameter for performing image processing on each image in the image sequence based on a noise amount (a noise amount corresponding to the noise amount (A′) in Formula 2 mentioned above) in an image to be perceived. The determination is made, for example, by detecting a parameter causing a value of the noise amount (A′) resulting from the image processing to be approximate to a reference noise amount (D). Thereby, a parameter suitable for an image having noise reduced due to the addition is detected by using the reference noise amount as a reference, among parameters each leading to a lower noise reduction effect than the parameter for a still image.

In this way, the parameter determination section 170 determines the parameter by using a viewer's (the user's) vision of images in a moving image (the after-image effect). The parameter determination section 170 supplies the image processing section 180 with the determined parameter. Note that the parameter determination section 170 is an example of an evaluation information generation section and a determination section in the scope of claims.

The image processing section 180 performs the image processing based on the parameter supplied from the parameter determination section 170. The image processing section 180 supplies the image output section 192 with the image subjected to the image processing.

The image output section 192 outputs the image sequence. For example, when the image processing apparatus 10 is the image-capturing apparatus such as the digital still camera, the output image sequence is recorded in, for example, a disk such as a DVD (Digital Versatile Disk) or a removable recording medium including a semiconductor memory such as a memory card. Further, when the image processing apparatus 10 is the video viewing apparatus, the image sequence is output to, for example, a display apparatus connected to the video viewing apparatus to be displayed in the display apparatus.

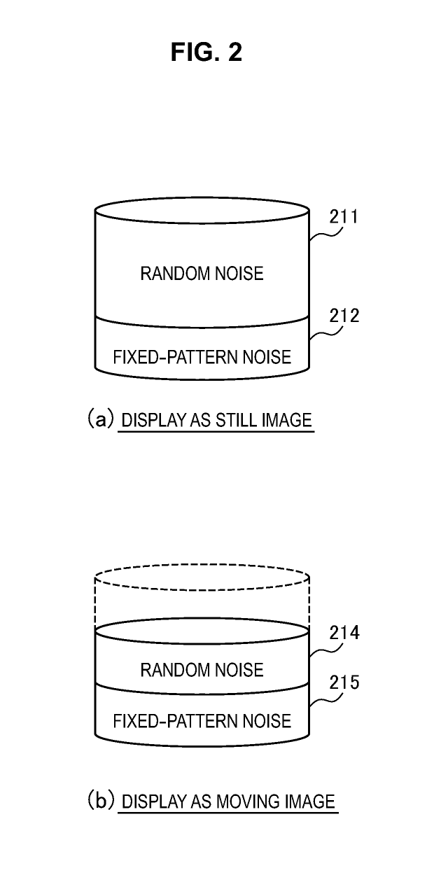

Next, a difference between a noise amount in displaying a still image and a noise amount in displaying a moving image will be described with reference to FIG. 2.

[Examples of Random Noise Amount and Fixed-Pattern Noise Amount]

FIG. 2 is a diagram schematically showing a noise amount taken into consideration when the parameter determination section 170 determines a parameter.

FIG. 2(a) shows a noise amount in displaying a still image, and FIG. 2(b) shows a noise amount (a perceived noise amount) perceived in displaying a moving image.

As shown in FIGS. 2(a) and (b), noise in an image includes random noise (random noise 211 and 214) and fixed-pattern noise (fixed-pattern noise 212 and 215).

When being displayed as a still image, an image is fixedly displayed, and thus the random noise included in the image is definitely recognized by the user. In contrast, when being displayed as a moving image, the image is variably displayed at speed corresponding to the frame rate of the moving image, and thus an image is perceived which is formed by adding up images the number of which corresponds to the time period of the time resolution of the viewer's vision. Thereby, the random noise is perceived as if the random noise were reduced (difference in size between the random noise 211 in FIG. 2(a) and the random noise 214 in FIG. 2(b)).

Note that the fixed-pattern noise occurs at the same position at all times in each image forming the moving image, and thus is not reduced even if the image is displayed as the moving image.

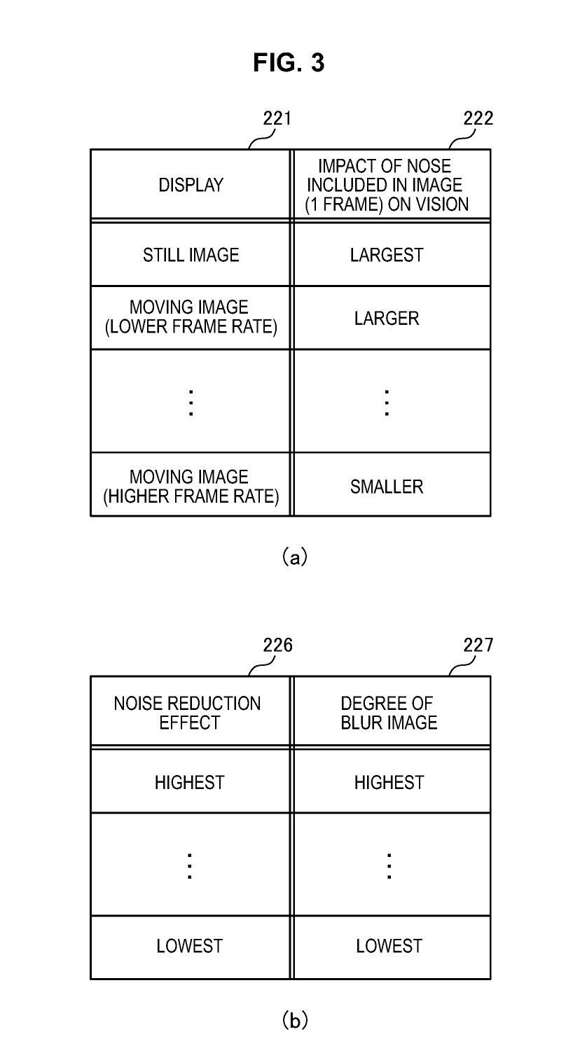

Next, variation in perceived noise amount depending on the frame rate and variation in image blur due to the noise reduction effect will be described with reference to FIG. 3.

[Example of Noise Amount and Example of Noise Reduction Effect]

FIG. 3 illustrates: a table showing variation in perceived noise amount depending on the frame rate of a moving image to be subjected to image processing by the moving-image processing section 100 in the first embodiment of the present technology; and a table showing variation in the degree of blur, of an image, caused by the noise reduction effect.

FIG. 3(a) illustrates a table showing relationships each between a frame rate (a column 221) of a moving image (in an image sequence) and an impact of noise included in an image on the vision (a column 222).

As shown in FIG. 3(a), the higher the frame rate, the larger the degree of reduction of the random noise. Accordingly, the higher the frame rate, the smaller the impact of the noise included in the image on the vision.

FIG. 3(b) illustrates a table showing relationships each between the degree of the noise reduction effect (a column 226) and the degree of blur of an image (a column 227).

As shown in FIG. 3(b), the higher the degree of the noise reduction effect, the higher the degree of processing an image. Accordingly, the higher the degree of the noise reduction effect, the higher the degree of blur of the image. For this reason, by performing the image processing using an image processing parameter leading to a noise reduction effect appropriate for a perceived noise amount, an image appropriately having the degree of the noise reduction effect and the resolutions of the image can be generated.

[Effect Example]

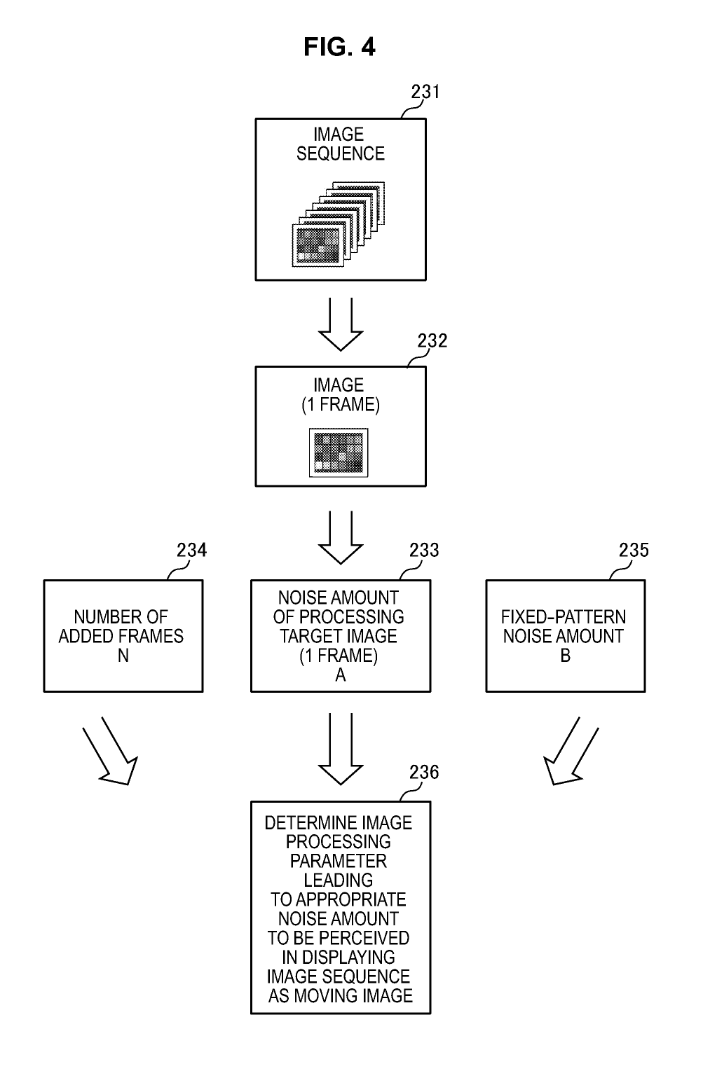

FIG. 4 is a diagram schematically showing how the moving-image processing section 100 in the first embodiment of the present technology determines a parameter.

When being supplied with an image sequence, the moving-image processing section 100 calculates an amount of noise (a noise amount A) included in one of images in the image sequence (see squares 231 to 233 in FIG. 4).

Then, the moving-image processing section 100 determines an image processing parameter leading to an appropriate amount of noise to be perceived in the user's vision, based on the number of frames (the number of added frames) N perceived as being added up in the user's vision, a fixed-pattern noise amount B, and a noise amount A (see squares 233 to 236 in FIG. 4).

In this way, an image processing parameter can be determined which leads to an appropriate image in displaying the image as a moving image. In other words, by determining the degree of the noise reduction in consideration of a random noise amount reduced in accordance with the number of added frames due to the vision, a noise reduction effect excessively exerted can be reduced, and thereby the resolutions and color reproducibility can be enhanced.

[Operation Example of Image Processing Apparatus]

Next, the image processing apparatus 10 in the first embodiment of the present technology will be described with reference to the drawings.

Note that various examples of an operation of the image processing apparatus 10 are conceivable, but here an example of updating an image processing parameter in the case of changing image-capturing conditions in the image-capturing apparatus will be described with reference to FIGS. 5 to FIG. 8. Further, an example of determining a parameter for each image forming a moving image (an image sequence) will be described with reference to FIG. 9.

FIG. 5 is a flowchart showing an example of a procedure used in image processing performed by the image processing apparatus 10 in the first embodiment of the present technology.

Here, the description is given on the assumption that the image-capturing apparatus such as the digital still camera is the image processing apparatus 10.

Firstly, it is determined whether or not to start image processing of a moving image (an image sequence) (Step S901). When it is determined that the image processing of the moving image is not to be started, the processing stands by until the image processing of the moving image is started. Note that the determination is made by, for example, a control section (not shown) in the image-capturing apparatus. When an image is output from an image sensor, it is determined that the image processing of the moving image is to be started.

On the other hand, when it is determined that the image processing of the moving image is to be started (Step S901), the frame rate acquisition section 120 acquires the frame rate of the moving image on which the image processing is to be performed (Step S902). Thereafter, the added-frame-number calculation section 140 calculates the number of added frames based on the acquired frame rate and visual information supplied from the visual information supply section 130 (Step S903).

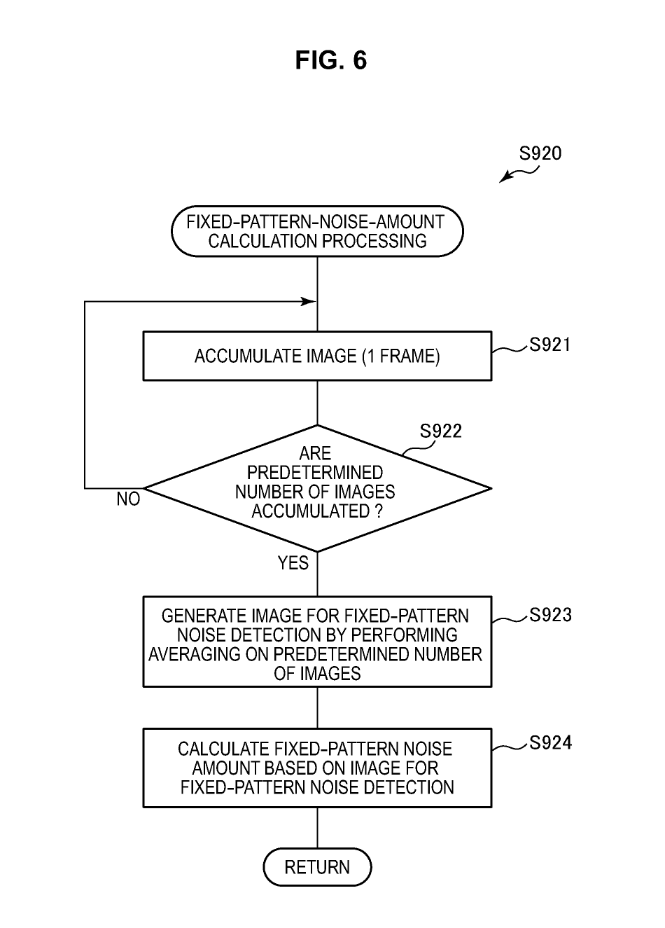

Then, the fixed-pattern-noise-amount calculation section 150 performs processing of calculating a fixed-pattern noise amount (fixed-pattern-noise-amount calculation processing) (Step S920). Note that a description of the fixed-pattern-noise-amount calculation processing (Step S920) will be given with reference to FIG. 6, and thus is omitted here. Further, when the image-capturing apparatus is the image processing apparatus 10, it is also possible to use a fixed-pattern noise amount held in advance in the image-capturing apparatus after being calculated based on the fixed-pattern noise measured at the time of manufacturing.

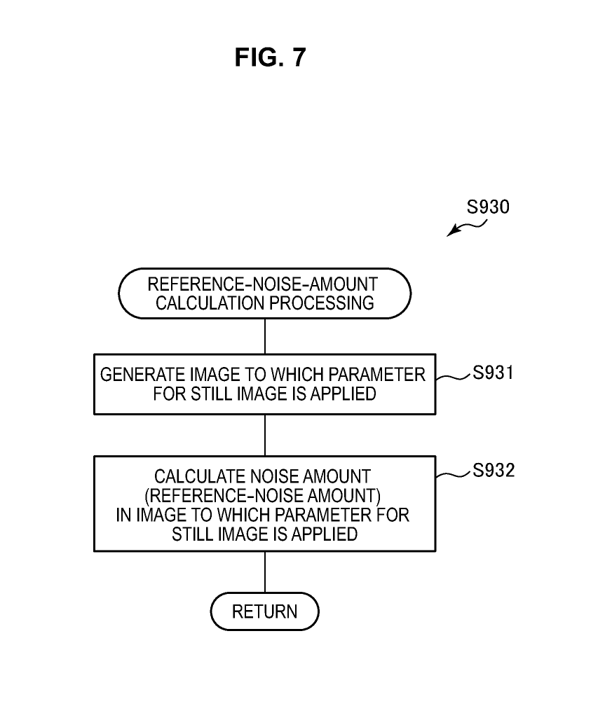

Next, the reference-noise-amount calculation section 160 performs processing (reference-noise-amount calculation processing) of calculating a noise amount (the reference noise amount) in an image subjected to image processing using a parameter for a still image (Step S930). Note that a description of the reference-noise-amount calculation processing (Step S930) will be given with reference to FIG. 7, and thus is omitted here.

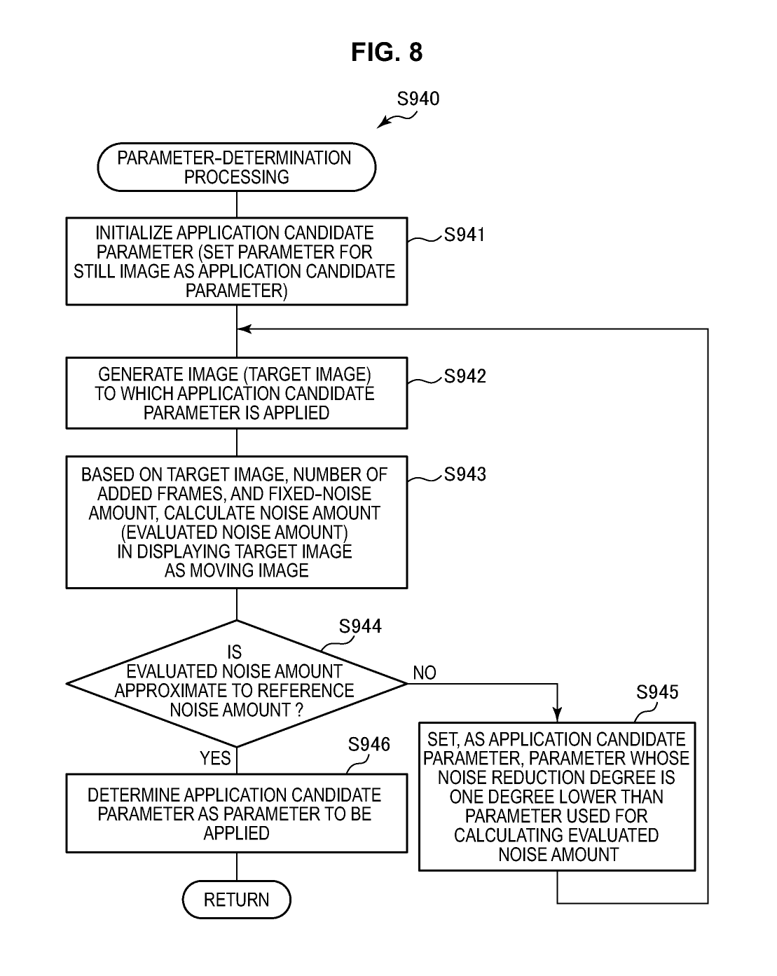

Thereafter, the parameter determination section 170 performs processing (parameter determination processing) of determining a parameter for performing image processing on images forming the moving image (Step S940). Note that a description of the parameter determination processing (Step S940) will be given with reference to FIG. 8, and thus is omitted here.

Then, the image processing section 180 performs the image processing using the determined parameter (Step S904), and outputs an image subjected to the image processing to the image output section 192 (Step S905).

Thereafter, it is determined whether or not to terminate the image processing of the moving image (Step S906). When it is determined that the image processing of the moving image is to be terminated, an operation of the image processing is terminated. The determination is made by, for example, the control section (not shown) in the image-capturing apparatus. When the image processing of all the images output from the image sensor after the moving image capturing is completed, it is determined that the image processing of the moving image is to be terminated.

On the other hand, when it is determined in Step S906 that the image processing of the moving image is not to be terminated (for example, there is an image yet to be processed), it is determined whether or not an image-capturing condition is changed (Step S907). Then, when it is determined that the image-capturing condition is not changed (Step S907), the processing moves back to Step S904 to continue the image processing using the determined parameter. In this way, the image processing is performed on each image of the moving image supplied from the image input section 191 by using the same parameter until the image-capturing condition is changed. Note that the determination is made by, for example, the control section in the image-capturing apparatus.

Alternatively, when it is determined that the image-capturing condition is changed (Step S907), the processing moves back to Step S930 to calculate a new reference noise amount and determine a new parameter. In this way, when the image-capturing condition is changed, the parameter is updated by using an image generated in accordance with the changed image-capturing condition.

Here, a description is given of the change of the image-capturing condition determined in Step S907. In Step S907, it is detected whether or not the image-capturing condition for changing signal processing for an image is changed. Since the change of the signal processing for the image frequently causes an increase or a decrease of an amount of noise included in the image, the determination of whether or not the image-capturing condition for changing signal processing for an image is changed makes it possible to predict the change of an amount of noise included in the image. Then, upon detection of the change of the image-capturing condition for changing signal processing for an image, a new parameter is determined by using an image captured in accordance with the changed image-capturing condition. Note that conceivable examples of the change of the image-capturing condition for changing signal processing for an image include change leading to brightness change of a captured image such as change of the degree of opening of a diaphragm, change of exposure time, or change of whether to use flash.

Next, the fixed-pattern-noise-amount calculation processing (Step S920) will be described with reference to FIG. 6.

FIG. 6 is a flowchart showing an example of a procedure of the fixed-pattern-noise-amount calculation processing (Step S920) in the image processing procedure in the first embodiment of the present technology.

Firstly, the fixed-pattern-noise-amount calculation section 150 accumulates the images supplied from the image input section 191 (Step S921). Next, the fixed-pattern-noise-amount calculation section 150 determines whether or not a predetermined number of images are accumulated (Step S922). Then, when it is determined that the predetermined number of images are accumulated (Step S922), the processing moves back to Step S921 to stand by until the predetermined number of images are accumulated.

On the other hand, when it is determined that the predetermined number of images are accumulated (Step S922), the fixed-pattern-noise-amount calculation section 150 generates an image (an image for fixed-pattern noise detection) formed by performing averaging on the predetermined number of images (Step S923). Thereafter, the fixed-pattern-noise-amount calculation section 150 calculates an amount of noise (a fixed-pattern noise amount) included in the image for fixed-pattern noise detection thus generated (Step S924), and an operation of the fixed-pattern-noise-amount calculation processing is terminated.

Next, the reference-noise-amount calculation processing (Step S930) will be described with reference to FIG. 7.

FIG. 7 is a flowchart showing an example of a procedure of the reference-noise-amount calculation processing (Step S930) in the image processing procedure in the first embodiment of the present technology.

Firstly, the reference-noise-amount calculation section 160 generates an image to which the parameter for a still image is applied to one of the images supplied from the image input section 191 (Step S931). Next, the reference-noise-amount calculation section 160 calculates the amount of noise (the reference noise amount) included in the generated image (Step S932), and an operation of the reference-noise-amount calculation processing is terminated.

Next, the parameter determination processing (Step S940) will be described with reference to FIG. 8.

FIG. 8 is a flowchart showing an example of a procedure of the parameter determination processing (Step S940) in the image processing procedure in the first embodiment of the present technology.

Firstly, the parameter determination section 170 initializes a parameter (an application candidate parameter) which is a candidate of a parameter to be used for the image processing, by setting the parameter for a still image as the application candidate parameter (Step S941). Next, the parameter determination section 170 performs image processing of applying the application candidate parameter on one of the images supplied from the image input section 191, and generates an image (a target image) subjected to the image processing by using the application candidate parameter (Step S942).

Then, based on the generated target image, the fixed-pattern noise amount, and the number of added frames, an amount of noise (an evaluated noise amount) to be perceived in displaying the target image as a moving image is calculated (Step S943). Note that the evaluated noise amount is calculated by using, for example, Formula 2 mentioned above. Note that Step S943 is an example of an evaluation information generation step described in the scope of claims.

Thereafter, it is determined whether or not the evaluated noise amount is approximate to the reference noise amount (Step S944). Then, when it is determined that the evaluated noise amount is not approximate to the reference noise amount (Step S945), a parameter whose degree of noise reduction is one degree lower than the parameter used for calculating the evaluated noise amount is set as the application candidate parameter (Step S945). Then, the processing moves back to Step S942. Note that Steps S944 and S946 are examples of a determination step described in the scope of claims.

On the other hand, when it is determined that the evaluated noise amount is approximate to the reference noise amount (Step S944), the application candidate parameter used for calculating the evaluated noise amount is determined as a parameter to be applied in the image processing (Step S946). Then, an operation of the parameter determination processing is terminated.

In this way, in the parameter determination processing (Step S940) it is determined whether or not the application candidate parameter is appropriate based on the amount of noise (the evaluated noise amount) to be perceived when the image subjected to the image processing using the application candidate parameter is displayed as a moving image. Note that the determination is made by comparing the evaluated noise amount with the reference noise amount. Since the parameter for a still image is set as an initial value, the evaluated noise amount calculated after the application of the parameter for a still image is smaller than the reference noise amount by an amount of the random noise reduced in accordance with the number of added frames.

Hence, starting from the parameter for a still image, the application candidate parameter is changed stepwise to a parameter having a lower degree of noise reduction to detect a parameter leading to approximately the same evaluated noise amount as the reference noise amount. Note that although it is stated that it is determined in Step S944 whether or not the evaluated noise amount is approximate to the reference noise amount, another example is also conceivable in which it is determined whether or not the evaluated noise amount exceeds the reference noise amount, because the parameter is changed stepwise to a parameter having a lower degree of noise reduction.

In this way, a parameter which has a lower noise reduction effect (the degree of noise reduction) than the parameter for a still image and is appropriate for viewing a moving image is determined in the parameter determination processing.

Next, an example of a procedure of the image processing in determining a parameter for each image forming a moving image will be described with reference to FIG. 9.

FIG. 9 is a flowchart showing the example of the procedure in determining a parameter for each image forming a moving image in the first embodiment of the present technology.

Note that the flowchart in FIG. 9 is a modification of the flowchart in FIG. 5, and is different only in that the parameter is determined for each image supplied from the image input section 191. In other words, the procedure shown in FIG. 9 includes a step (Step S951) of acquiring a next image in the moving image, instead of the step (Step S907) of determining whether or not the image-capturing condition is changed in the procedure in FIG. 5. Upon acquisition of the next image in the moving image (Step S951), the processing moves back to Step S930. After a new reference noise amount is calculated, a new parameter is determined.

In this way, according to the first embodiment of the present technology, the parameter for adjusting the image quality of the moving image can be appropriately determined by determining the image processing parameter based on a perceived noise amount.

### 2. Second Embodiment

In the first embodiment of the present technology, the description has been given of the example of calculating the perceived noise amount by using Formula 2 mentioned above. That is, the noise amount is calculated by using computation based on the reduction of random noise to 1/√N due to the addition of N images.

Note that the perceived noise amount can also be calculated by actually adding images and then calculating a noise amount in the calculated images.

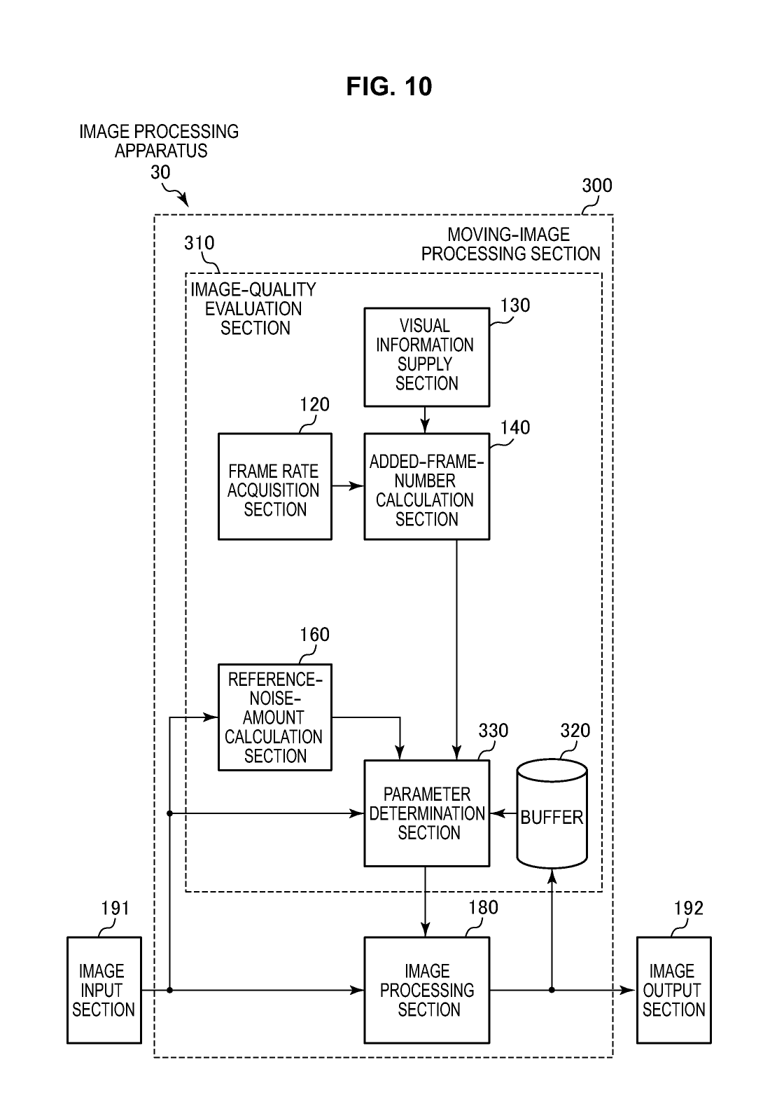

Hence, in a second embodiment of the present technology, an example of adding up (combining) images based on the number of added frames to determine a parameter based on the added images will be described with reference to FIGS. 10 to 12.

[Functional Configuration Example of Image Processing Apparatus]

FIG. 10 is a block diagram showing a functional configuration example of an image processing apparatus (an image processing apparatus 30) in the second embodiment of the present technology.

Note that the image processing apparatus 30 shown in FIG. 10 is a modification of the image processing apparatus 10 shown in FIG. 1. Accordingly, the same configuration in FIG. 10 as in FIG. 1 is denoted with the same reference numerals, and a description thereof is omitted here. A moving-image processing section 300 shown in FIG. 10 includes an image-quality evaluation section 310 and the image processing section 180. Note that the image processing apparatus 30 shown in FIG. 10 is different from the image processing apparatus 10 in FIG. 1 only in a configuration of the image-quality evaluation section 310. Hence, focusing on the image-quality evaluation section 310, the description will be given for FIG. 10.

In addition, the description will be given for FIG. 10 on the assumption that the number of added frames (n) is an integer, for convenience of explanation.

The image-quality evaluation section 310 includes the frame rate acquisition section 120, the visual information supply section 130, the added-frame-number calculation section 140, the reference-noise-amount calculation section 160, a buffer 320, and a parameter determination section 330. Note that the configuration of the image processing apparatus 30 is the same as that shown in FIG. 1 except the buffer 320 and the parameter determination section 330, and thus a description thereof is omitted here.

The buffer 320 is a buffer which holds images after image processing which are output by the image processing section 180. Every time the image processing section 180 outputs a newest processed image, the buffer 320 holds the image. In the case of a space shortage, the buffer 320 discards the oldest image. Note that the buffer 320 accumulates a minimum number of images which is the number (n−1) one smaller than the number shown by the number of added frames (n). For this reason, as the size of the buffer 320, a size is set which allows accumulation of images the number of which is, for example, an upper limit of the assumed number of added frames (n). The buffer 320 supplies the parameter determination section 330 with the images held in the buffer 320.

The parameter determination section 330 determines a parameter in image processing of each image forming the image sequence, like the parameter determination section 170 in FIG. 1. From the buffer 320, the parameter determination section 330 acquires images the number (n−1) of which is one smaller than the number shown by the number of added frames (n) supplied from the added-frame-number calculation section 140. Note that the images acquired from the buffer 320 by the parameter determination section 330 are n−1 images counted from the latest image held in the buffer 320. Then, the parameter determination section 330 adds up an image supplied from the image input section 191 and the n−1 images acquired from the buffer 320 to generate an image (an added image) considered to be perceived by the viewer.

Then, the parameter determination section 330 calculates a noise amount of the generated added image, and determines a parameter by using the calculated noise amount. Note that since the parameter is determined by the same method as that in the first embodiment of the present technology, a description of the method is omitted here.

In this way, the parameter determination section 330 generates an image close to a perceived image by adding a plurality of mages, and determines the parameter by using the noise amount in the generated image.

[Example of Effects]

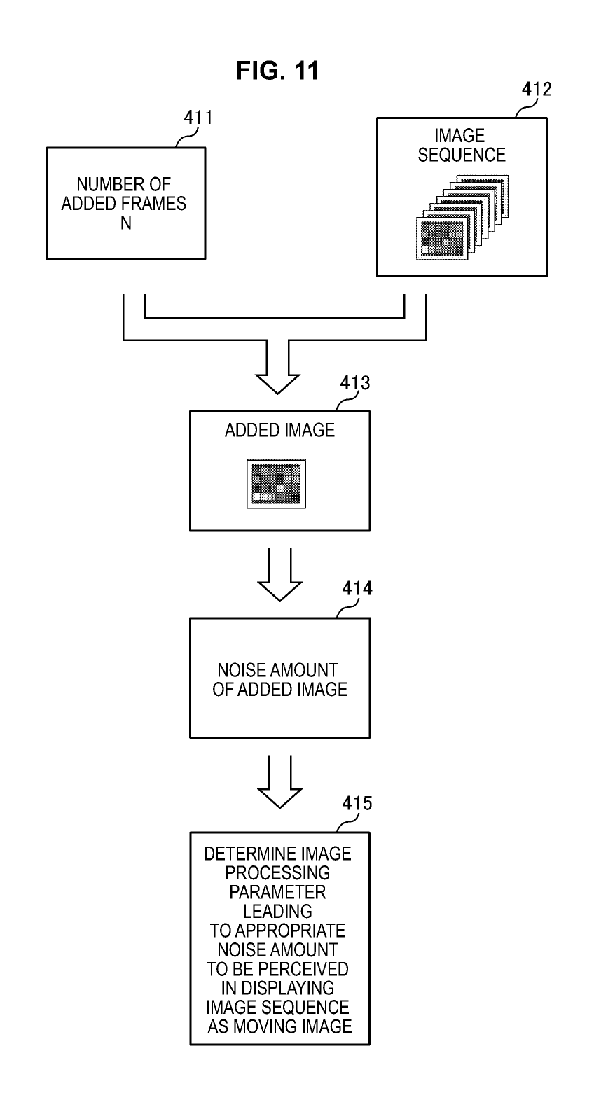

FIG. 11 is a diagram schematically showing how the moving-image processing section 300 in the second embodiment of the present technology determines the parameter.

The moving-image processing section 300 adds up a plurality of images based on the number of frames (the number of added frames) added up in the vision in displaying the images as a moving image, and generates an image (an added image) assumed to be viewed (see squares 411 to 413 in FIG. 11). Then, the moving-image processing section 300 calculates an amount of noise included in the added image (a square 414 in FIG. 11) and determines an image processing parameter by using the calculated noise amount (a square 415 in FIG. 11).

[Operation Example of Image Processing Apparatus]

Next, an operation of the image processing apparatus 30 in the second embodiment of the present technology will be described with reference to the drawings.

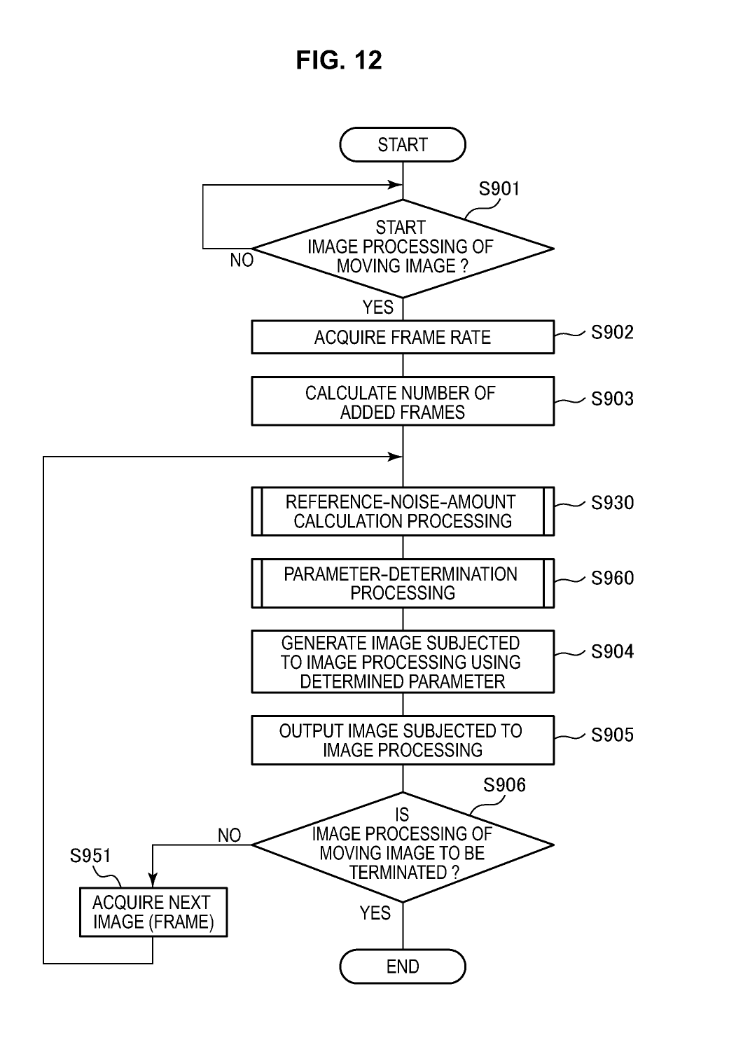

FIG. 12 is a flowchart showing an example of a procedure used in image processing performed by the image processing apparatus 30 in the second embodiment of the present technology.

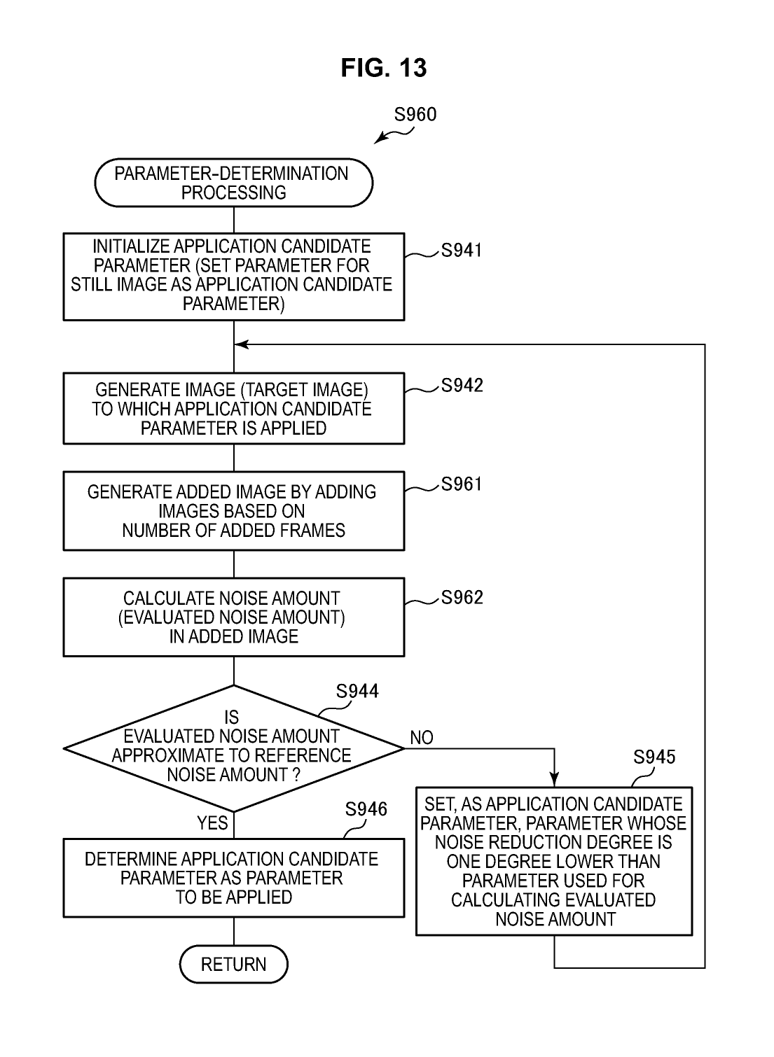

Note that the flowchart in FIG. 12 is a modification of the flowchart in FIG. 9 and is different only in that the step of the fixed-pattern-noise-amount calculation processing (see Step S920 in FIG. 9) is eliminated and that the processing content of the parameter determination processing is different. Hence, the parameter determination processing is set as Step S960 in the flowchart in FIG. 12. A description of the parameter determination processing (Step S960) will be described with reference to FIG. 13.

FIG. 13 is a flowchart showing an example of a procedure of the parameter determination processing (Step S960) in an image processing procedure in the second embodiment of the present technology.

Note that the flowchart in FIG. 13 is a modification of the flowchart in FIG. 8 and is different in that an image (an added image) considered to be perceived by the viewer is generated by adding up the plurality of images. In other words, the flowchart in FIG. 13 includes steps of generating an added image and calculating an evaluated noise amount (Steps S961 and S962) instead of Step S943 in FIG. 8. Note that since steps other than these steps are the same as those in the flowchart in FIG. 8, descriptions thereof are omitted here.

After a target image is generated in Step S942, the parameter determination section 330 generates an image (an added image) by adding up the target image and a plurality of images (the number of which is the number of added frames (n)−1) acquired from the buffer 320 (Step S961). Then, an amount of noise (an evaluated noise amount) included in the added image thus generated is calculated (Step S962), and thereafter the processing moves to Step S944.

In this way, the second embodiment of the present technology makes it possible to calculate the perceived noise amount by using the image generated by adding up the plurality of images, and to determine an image processing parameter. Note that the second embodiment of the present technology has the processing of adding up the plurality of images leading to higher processing load than the first embodiment of the present technology has, but makes it possible to generate the noise amount from an image close to an actually perceived image and thus to determine the parameter with higher accuracy.

### 3. Third Embodiment

In the first and second embodiments of the present technology, the descriptions have been given of the example in which a parameter is determined by using, as a reference, a noise amount calculated in the case of applying a parameter for a still image. In this way, the parameter can be determined with high accuracy. Meanwhile, other various methods are conceivable as the parameter determination method. For example, a case is conceivable where a parameter is determined by using a list in which calculated noise amount values and parameters are associated with each other. In this case, since the processing load is low, the parameter can be determined quickly.

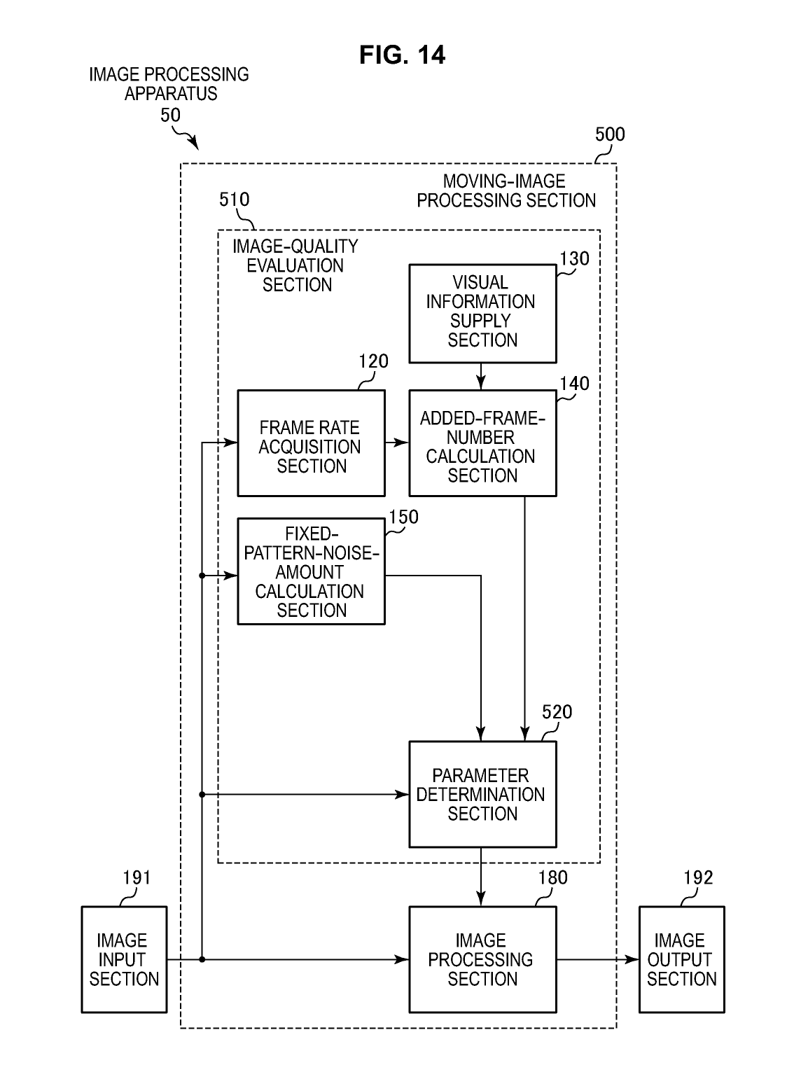

Hence, in a third embodiment of the present technology, an example of determining a parameter by using a list in which calculated noise amount values and parameters are associated with each other will be described with reference to FIGS. 14 to 16.

[Functional Configuration Example of Image Processing Apparatus]

FIG. 14 is a block diagram showing a functional configuration example of an image processing apparatus (an image processing apparatus 50) in the third embodiment of the present technology.

Note that the image processing apparatus 50 shown in FIG. 14 is a modification of the image processing apparatus 10 shown in FIG. 1 and is different in that the reference noise amount is not used in determining a parameter by a parameter determination section (a parameter determination section 520). In other words, the image processing apparatus 50 does not include the reference-noise-amount calculation section 160. Further, the configuration of the image processing apparatus 50 is the same as that shown in FIG. 1 except the parameter determination section 520, and thus a description thereof is omitted here.

The parameter determination section 520 determines a parameter in image processing like the parameter determination section 170 in FIG. 1. The parameter determination section 520 calculates a noise amount of an image supplied from the image input section 191. By using the calculated noise amount, the number of added frames, the fixed-pattern noise amount, and Formula 2 mentioned above (see the description given with reference to FIG. 1), the parameter determination section 520 calculates a noise amount in an added image in the vision. Then, the parameter determination section 520 determines the parameter by using a list (a parameter list) in which noise amounts and parameters are associated with each other. In other words, the parameter determination section 520 searches the list for a parameter associated with a value of the calculated noise amount, and determines the parameter thus searched for as a parameter to be used for the image processing.

[Parameter List Example]

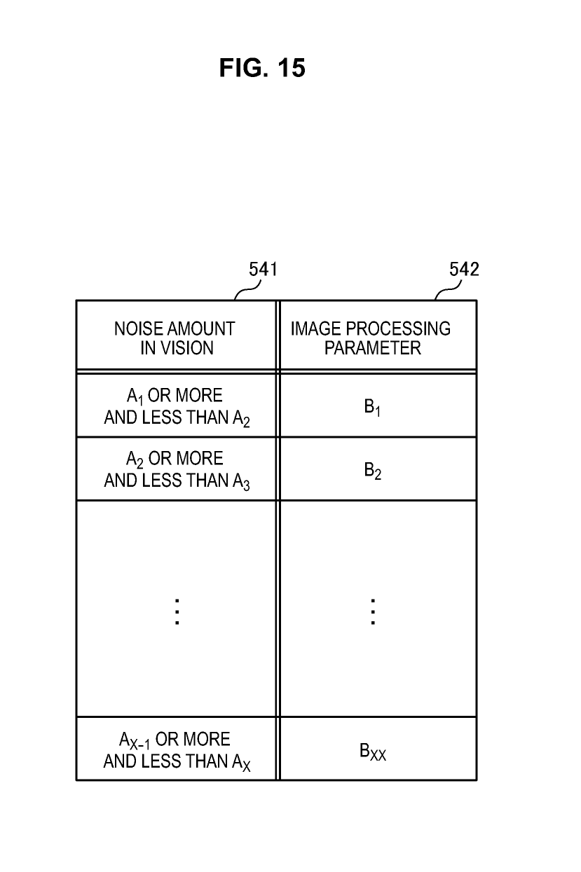

FIG. 15 is a table showing an example of a parameter list used when a moving-image processing section 500 in the third embodiment of the present technology determines a parameter.

As shown in FIG. 15, the parameter list is a list in which noise amounts (a column 541) and image processing parameters (a column 542) are associated with each other. By using such a list, the parameter can be determined with low processing load.

[Operation Example of Image Processing Apparatus]

Next, an operation of the image processing apparatus 50 in the third embodiment of the present technology will be described with reference to the drawings.

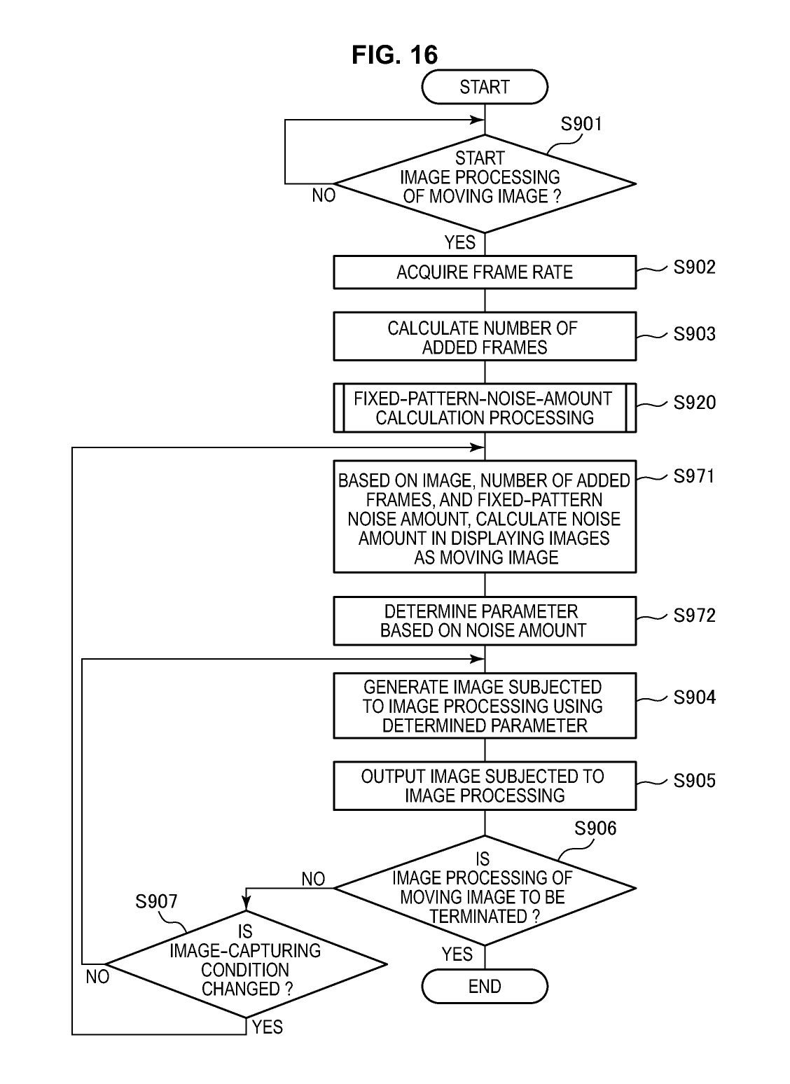

FIG. 16 is a flowchart showing an example of a procedure used in image processing performed by the image processing apparatus 50 in the third embodiment of the present technology.

Note that the flowchart in FIG. 16 is a modification of the flowchart in FIG. 5. Hence, the same steps in the flowchart in FIG. 16 as those in the flowchart in FIG. 5 are denoted with the same reference numerals, and descriptions thereof are omitted here.

After a fixed-pattern noise amount is calculated in Step S920, a noise amount to be perceived in displaying images as a moving image is calculated based on one of the images supplied from the image input section 191, the number of added frames, and the fixed-pattern noise (Step S971). Thereafter, a parameter associated with the calculated noise amount is searched for by using the parameter list (see FIG. 15). After the parameter thus searched for is determined as the parameter for the image processing (Step S972), the processing moves to Step S904.

In this way, the third embodiment of the present technology makes it possible to determine the parameter quickly by using the list in which the noise amounts and the parameters are associated with each other.

Note that the examples in which the parameter change causes enhancement or deterioration of the noise reduction effect have been described, but are not limited thereto. For example, a case is also conceivable in which the parameter change causes enhancement or deterioration of color reproducibility of a color matrix. When a noise amount to be reduced is small, a color matrix having high color reproducibility can be used to enhance the image quality in displaying a moving image. Further, when the present technology is carried out in an image-capturing apparatus, change of setting (for example, ISO sensitivity) in the image-capturing apparatus can cause the enhancement of the image quality. For example, a high frame rate leads to a high reduction effect of a perceived noise amount, and thus a set value for low ISO sensitivity is used. In contrast, a low frame rate leads to a low reduction effect of the perceived noise amount, and thus a set value for high ISO sensitivity is used.

Note that the second embodiment of the present technology has been described on the assumption that the number of added frames (n) is an integer, but is not limited thereto. The present technology can be carried out likewise also in the case of a noninteger. For example, when the number of added frames is “5.5”, the present technology can be carried out likewise in the following way. Specifically, five images are added up, six images are added up, and a noise amount average in these cases is calculated. Then, a parameter is determined by using the average noise amount.

Note that let us assume the case where the present technology is carried out in the video viewing apparatus. When frame interpolation or the like causes a difference between a frame rate of an input moving image and a frame rate of the displayed moving image, the present technology can be carried out likewise by using the frame rate at the time of the displaying and the image subjected to the frame interpolation.

In this way, the embodiments of the present technology make it possible to appropriately determine a parameter for adjusting an image quality of a moving image.

Note that the aforementioned embodiments are shown as examples of embodying the present technology, and there is a correspondence between a matter in the embodiments and a matter specifying the present technology in the scope of claims. Likewise, there is a correspondence between a matter specifying the present technology in the scope of claims and a matter having the same name in the embodiments of the present technology. The present technology, however, is not limited to the embodiments, and can be embodied by making various modifications to the embodiments without departing from the gist of the technology.

Further, the procedures described in each of the aforementioned embodiments may be understood as a method including a series of these procedures, and may be understood as a program for causing a computer to execute the series of these procedures or a recording medium storing the program therein. As the recording medium, for example, a hard disk, a CD (a Compact Disc), an MD (a MiniDisc), a DVD (a Digital Versatile Disk), a memory card, or Blu-ray Disc (registered trademark) can be used.

Additionally, the present technology may also be configured as below.
(1) An image processing apparatus including:

an evaluation information generation section which generates, based on a moving image and a frame rate of the moving image, evaluation information for specifying an image quality of the moving image in displaying the moving image at the frame rate; and

a determination section which determines a parameter for adjusting the image quality of the moving image based on the generated evaluation information.
(2) The image processing apparatus according to (1),

wherein the evaluation information is information for specifying an image quality of one of images forming the moving image displayed at the frame rate, the image being perceived by a user at a time of viewing, and

wherein the evaluation information generation section generates the evaluation information based on the image, the frame rate, and visual information on a vision of the user.
(3) The image processing apparatus according to (2),

wherein the visual information is information indicating a predetermined time period related to an after-image perceived by the user, and

wherein the evaluation information generation section calculates a number of images displayed in the predetermined time period based on the frame rate, and generates as the evaluation information an amount of noise specified based on the calculated number of images.
(4) The image processing apparatus according to (3),

wherein the predetermined time period is a time period approximate to a time period of a time resolution of the vision.
(5) The image processing apparatus according to (3) or (4),

wherein the amount of noise includes a random noise amount which is an amount of random noise and a fixed-pattern noise amount which is an amount of fixed-pattern noise, and

wherein the evaluation information generation section calculates the random noise amount based on the amount of noise of the image, the number of images displayed in the predetermined time period, and the fixed-pattern noise amount, and generates as the evaluation information the specified amount of noise based on a sum of the calculated random noise amount and the fixed-pattern noise amount.
(6) The image processing apparatus according to (3) or (4),

wherein among the images forming the moving image, the evaluation information generation section combines images a number of which is equal to the number of images into a combined image, and generates the evaluation information which is an amount of noise in the combined image.
(7) The image processing apparatus according to (1),

wherein the determination section determines as the parameter at least one of a parameter for adjusting a degree of noise reduction, a parameter for adjusting a degree of color reproducibility of a color matrix, or a parameter for adjusting a setting for image capturing.
(8) An electronic device including:

an evaluation information generation section which generates, based on a moving image and a frame rate of the moving image, evaluation information for specifying an image quality of the moving image in displaying the moving image at the frame rate;

a determination section which determines a parameter for adjusting the image quality of the moving image based on the generated evaluation information; and

an output section which outputs the moving image adjusted by using the determined parameter.
(9) An image processing method including:

generating, based on a moving image and a frame rate of the moving image, evaluation information for specifying an image quality of the moving image in displaying the moving image at the frame rate; and

determining a parameter for adjusting the image quality of the moving image based on the generated evaluation information.
(10) A program for causing a computer to execute the procedures of:

generating, based on a moving image and a frame rate of the moving image, evaluation information for specifying an image quality of the moving image in displaying the moving image at the frame rate; and

determining a parameter for adjusting the image quality of the moving image based on the generated evaluation information.

The present disclosure contains subject matter related to that disclosed in Japanese Priority Patent Application JP 2012-055223 filed in the Japan Patent Office on Mar. 13, 2012, the entire content of which is hereby incorporated by reference.

What is claimed is:

1. An image processing apparatus comprising:
an evaluation information generation section which generates, based on a moving image and a frame rate of the moving image, evaluation information for specifying an image quality of the moving image in displaying the moving image at the frame rate; and
a determination section which determines a parameter for adjusting the image quality of the moving image based on the generated evaluation information.

2. The image processing apparatus according to claim 1,
wherein the evaluation information is information for specifying an image quality of one of images forming the moving image displayed at the frame rate, the image being perceived by a user at a time of viewing, and
wherein the evaluation information generation section generates the evaluation information based on the image, the frame rate, and visual information on a vision of the user.

3. The image processing apparatus according to claim 2,
wherein the visual information is information indicating a predetermined time period related to an after-image perceived by the user, and
wherein the evaluation information generation section calculates a number of images displayed in the predetermined time period based on the frame rate, and generates as the evaluation information an amount of noise specified based on the calculated number of images.

4. The image processing apparatus according to claim 3,
wherein the predetermined time period is a time period approximate to a time period of a time resolution of the vision.

5. The image processing apparatus according to claim 3,
wherein the amount of noise includes a random noise amount which is an amount of random noise and a fixed-pattern noise amount which is an amount of fixed-pattern noise, and
wherein the evaluation information generation section calculates the random noise amount based on the amount of noise of the image, the number of images displayed in the predetermined time period, and the fixed-pattern noise amount, and generates as the evaluation information the specified amount of noise based on a sum of the calculated random noise amount and the fixed-pattern noise amount.

6. The image processing apparatus according to claim 3,
wherein among the images forming the moving image, the evaluation information generation section combines images a number of which is equal to the number of images into a combined image, and generates the evaluation information which is an amount of noise in the combined image.

7. The image processing apparatus according to claim 1,
wherein the determination section determines as the parameter at least one of a parameter for adjusting a degree of noise reduction, a parameter for adjusting a degree of color reproducibility of a color matrix, or a parameter for adjusting a setting for image capturing.

8. An electronic device comprising:
an evaluation information generation section which generates, based on a moving image and a frame rate of the moving image, evaluation information for specifying an image quality of the moving image in displaying the moving image at the frame rate;
a determination section which determines a parameter for adjusting the image quality of the moving image based on the generated evaluation information; and
an output section which outputs the moving image adjusted by using the determined parameter.

9. An image processing method comprising:
generating, based on a moving image and a frame rate of the moving image, evaluation information for specifying an image quality of the moving image in displaying the moving image at the frame rate; and
determining a parameter for adjusting the image quality of the moving image based on the generated evaluation information.

10. A program for causing a computer to execute the procedures of:
generating, based on a moving image and a frame rate of the moving image, evaluation information for specifying an image quality of the moving image in displaying the moving image at the frame rate; and
determining a parameter for adjusting the image quality of the moving image based on the generated evaluation information.
